(19) United States
(12) Patent Application Publication
(10) Pub. No.: US 2012/0107042 A1
(43) Pub. Date: May 3, 2012

(54) Blind and pre-loaded mortise and tenon joint

(76) Inventor: Wallace Schneider, New York, NY (US)

(21) Appl. No.: 12/925,900

(22) Filed: Nov. 1, 2010

(51) Int. Cl. F16D 1/00; F16B 7/18

(52) U.S. Cl. 403/343; 403/381

(57) ABSTRACT

A blind and pre-loaded mortise and tenon joint. The joint includes a first joint part, a second joint part, and at least one wedge. The first joint part has a tenon extending outwardly therefrom. The second joint part has a mortise extending therein. The at least one wedge is pre-loaded into the tenon of the first joint part before the tenon of the first joint part is inserted into the mortise of the second joint part so as to allow the tenon of the first joint part to expand against the mortise of the second joint part as the at least one wedge drives further into the tenon of the first joint part by engaging the mortise of the second joint part until the tenon of the first joint part bottoms out in the mortise of the second joint part at which time the tenon of the first joint part is blindly captured in the mortise of the second joint part.

### 1. BACKGROUND OF THE INVENTION

A. Field of the Invention

The embodiments of the present invention relate to a mortise and tenon joint, and more particularly, the embodiments of the present invention relate to a blind and pre-loaded mortise and tenon joint.

B. Description of the Prior Art

Numerous innovations for joints have been provided in the prior art, which will be described below in chronological order to show advancement in the art, and which are incorporated herein by reference thereto. Even though these innovations may be suitable for the specific individual purposes to which they address, however, they differ from the present invention in that they do not teach blind and pre-loaded mortise and tenon joint.

(1) U.S. Pat. No. 422,843 to Smith.

U.S. Pat. No. 422,843 issued to Smith on Mar. 4, 1890 teaches a blind mortise-joint for a door and other frames, which includes a part having a dovetailed mortise, a part having a tenon, and a rectilinear wedge-bar whose dimensions are substantially equal to one end of the tenon for compressing the tenon endwise and spreading it laterally.

(2) U.S. Pat. No. 879,382 to Harris.

U.S. Pat. No. 879,382 issued to Harris on Feb. 18, 1908 teaches a frame having a mortise therein. The walls of the mortise are tapered for a tenon to be adapted to enter the mortise. A tubular wedge has an edge at one end thereof, and is split from end-to-end, whereby the wedge may yield. The wedge is concentrically disposed in the mortise, and adapted to enter the tenon and force the outer portion thereof into engagement with the tapered walls of the mortise.

(3) U.S. Pat. No. 2,021,490 to Rigandi.

U.S. Pat. No. 2,021,490 issued to Rigandi on Nov. 19, 1935 in U.S. class 306 and subclass 33 teaches a tool-handle fastening device including a tool head having a handle receiving socket. Two opposite side walls of the socket have openings therein. A bottom wall of the socket is closed. A perforated wedge is formed integral with the bottom wall of the socket and projects therefrom into the socket to a point beyond the inner edges of the openings in the side walls thereof. A rib refines the inner edge of each opening in the side walls of the socket. A handle has one end adapted to be received in the socket and provided with a pre-formed slot to receive the wedge. The wedge serves to expand the handle into the openings in the opposite side walls of the socket and into engagement with the ribs when the handle is driven home in the socket. A cross pin is adapted to pass through the end of the handle and the perforation in the wedge.

(4) U.S. Pat. No. 2,228,238 to Padgett.

U.S. Pat. No. 2,228,238 issued to Padgett on Sep. 30, 1947 in U.S. class 306 and subclass 33 teaches a wedging device for a tool head formed with an eye for receiving a handle. The device includes beveled surfaces provided on opposing sides of the eye in the head. A pair of side plates are receivable in the eye, between the sides and the sides of the handle. A plurality of in-turned teeth are on each of the plates. A tapered wedge plate is insertable into the end of the handle. The surfaces force the teeth into the sides of the handle. One of the side plates is formed with an aperture and a prong provided on the remaining of the side plates. A mid-portion of the prong engages the wedge plate, and the end portion of the prong is receivable in the aperture.

(5) U.S. Pat. No. 2,614,302 to Johnson.

U.S. Pat. No. 2,614,302 issued to Johnson on Oct. 21, 1952 in U.S. class 20 and subclass 92 teaches a joint for an article of furniture. The joint connects two parts in abutting relation without interposition of adjunctive elements. The joint includes one member having formed in it a mortise of given depth extending inwardly from one edge and terminating short of any other edge. A major portion of the mortise is of rectangular cross section, and the remainder near the terminal end has inclined re-entrant walls. The other member has at its abutting end an integrally formed tenon. A portion of the tenon is of rectangular cross section, and is slidably engaged within the rectangular portion of the mortise, and another portion of the tenon has a dovetail cross section. The inclined walls of the tenon are the converse of that portion of the mortise having the re-entrant walls and is situated therein. A body of bonding material unites the inclined walls of the dovetail portion of the tenon with the inclined walls of the mortise. The rectangular portion of the mortise and tenon are free of bonding material, and free to come and go relative to each other.

(6) U.S. Pat. No. 3,664,011 to Labastrou.

U.S. Pat. No. 3,664,011 issued to Labastrou on May 23, 1972 in U.S. class 144 and subclass 347 teaches a method and way for making a continuous joint between panel members. The new joint is a modified form of a dovetail joint and preserves the rigidity of assembly, which is characteristic thereto, while being as easy to assemble and disassemble as a tongue and groove joint.

(7) U.S. Pat. No. 3,991,535 to Keller et al.

U.S. Pat. No. 3,991,535 issued to Keller et al. on U.S. Pat. No. 3,991,535 in U.S. class 52 and subclass 642 teaches a joint including a pair of parallel tongues of uniform thickness on an edge of one member, which are pressed into grooves of uniform width in another member. The grooves are inclined from top to bottom relative to each other, bending the tongues out of parallelism and thereby locking them in the grooves to form a self-locking joint equivalent to a dovetail joint. Such tongues on the top and bottom edges of a vertical member are pressed into longitudinal grooves in elongated top and bottom chord members to form an I-beam or truss section. The tongues may be formed on the edge of a board or they may include the opposite face sheets on a plywood panel. Also, the joint members may be metal.

(8) U.S. Pat. No. 4,042,307 to Jarvis.

U.S. Pat. No. 4,042,307 issued to Jarvis on Aug. 16, 1977 in U.S. class 403 and subclass 290 teaches a joint formed by pushing a grooved tenon into a dovetail-shaped mortise containing a barbed wedge such that the wedge is forced into the tenon groove, thereby spreading the tenon to the dovetail shape of the mortise and anchoring the barbs into the tenon, thus securing the joint and preventing the tenon and mortise from separating.

(9) U.S. Pat. No. 4,479,523 to Peterson et al.

U.S. Pat. No. 4,479,523 to issued to Peterson et al. on U.S. Pat. No. 4,479,523 in U.S. class 144 and subclass 144.51 teaches a patterning jig for use with a router, which has a flat template with space-opposed side margins joined by respective front and rear margins. A first opening through the template is spaced inwardly a predetermined distance from one of the side margins and is centered on a line running between those side margins inwardly from the front margin. Also formed in the template is a tongue centered on that line, disposed toward the other of the side margins from the opening and positioned between a pair of open spaces defined through the template. A flat guide projects downwardly from the template parallel to and spaced inwardly of the line from the front margin. Various other accessory components for expanding upon the facility of usage are provided.

(10) U.S. Pat. No. 4,492,489 to Kantorowich.

U.S. Pat. No. 4,492,489 issued to Kantorowich on U.S. Pat. No. 4,492,489 in U.S. class 403 and subclass 319 teaches a mortice and tenon joint of two structural members, which avoids the protrusion of the tenon beyond the mortice. Across the tenon of one member there is cut a dovetail aperture or slot, and a movable tapering wedge of similar dovetail cross-section is slidably housed within a tapering channel also of similar dovetail cross-section which crosses the mortice of the other member such that when the tenon is inserted wholly into the mortice the wedge may be driven along the tapered channel to become firmly engaged within the dovetail aperture or slot thus to lock the members together and prevent them from separating until the wedge is withdrawn.

(11) U.S. Pat. No. 5,458,171 to Ward.

U.S. Pat. No. 5,458,171 issued to Ward on Oct. 17, 1995 in U.S. class 144 and subclass 84 teaches an apparatus for making tenons and mortises, which includes a table with a first opening in a top surface thereof. The top surface is disposed for receiving a sliding base assembly for a cutting device having a second opening therein. A work-piece holding assembly is detachably connected to a front portion of the table. The table and sliding base assembly cooperate to define movement of the sliding base assembly in relation to the first opening. The work-piece holding assembly is positionable at preselected angles and varying vertical positions in relation to the top surface of the table.

(12) U.S. Pat. No. 6,520,708 to Jung et al.

U.S. Pat. No. 6,520,708 issued to Jung et al. on Feb. 18, 2003 in U.S. class 403 and subclass 282 teaches a device for connecting two parts for the sake of high-precision fixation of the two parts in a defined positioning to one another, two connection pairs are provided, each including one wedge-like tab, assigned to the first part and extending in the connection direction, and one wedge-shaped notch, assigned to the other part and extending in the connection direction, with a course of the wedge that is contrary to that to the tab, and into which notch the tab can be pressed, causing deformation. The two connection pairs are oriented such that the press-in directions of the tabs into the assigned notches are opposite one another in terms of the connection direction.

It is apparent that numerous innovations for joints have been provided in the prior art that are adapted to be used. Furthermore, even though these innovations may be suitable for the specific individual purposes to which they address, however, they would not be suitable for the purposes of the embodiments of the present invention as heretofore described, namely, a blind and pre-loaded mortise and tenon joint.

### 2. SUMMARY OF THE INVENTION

Thus, an object of the embodiments of the present invention is to provide a blind and pre-loaded mortise and tenon joint, which avoids the disadvantages of the prior art.

Briefly stated, another object of the embodiments of the present invention is to provide a blind and pre-loaded mortise and tenon joint. The joint includes a first joint part, a second joint part, and at least one wedge. The first joint part has a tenon extending outwardly therefrom. The second joint part has a mortise extending therein. The at least one wedge is pre-loaded into the tenon of the first joint part before the tenon of the first joint part is inserted into the mortise of the second joint part so as to allow the tenon of the first joint part to expand against the mortise of the second joint part as the at least one wedge drives further into the tenon of the first joint part by engaging the mortise of the second joint part until the tenon of the first joint part bottoms out in the mortise of the second joint part at which time the tenon of the first joint part is blindly captured in the mortise of the second joint part.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic perspective view of a chair utilizing the blind and pre-loaded mortise and tenon joint of an embodiment of the present invention;

FIG. 2 is an enlarged and exploded diagrammatic perspective view of the area generally enclosed in the dotted curve identified by ARROW 2 in FIG. 1 of the blind and pre-loaded mortise and tenon joint of an embodiment of the present invention;

FIG. 3 is an enlarged diagrammatic perspective view of the area generally enclosed by the dotted curve identified by ARROW 3 in FIG. 2 of the wedge of the blind and pre-loaded mortise and tenon joint of an embodiment of the present invention;

FIG. 4 is a diagrammatic cross sectional view taken along LINE 4-4 in FIG. 3;

FIG. 5 is an enlarged diagrammatic cross sectional view taken along LINE 5-5 in FIG. 2 of the initial step of inserting the wedges into the tenon of the blind and pre-loaded mortise and tenon joint of an embodiment of the present invention;

FIG. 6 is an enlarged diagrammatic cross sectional view taken along LINE 6-6 in FIG. 2 of the intermediate step of bottoming out the wedges in the mortise of the blind and pre-loaded mortise and tenon joint of an embodiment of the present invention;

FIG. 7 is an enlarged diagrammatic cross sectional view taken along LINE 7-7 in FIG. 2 of the final step of driving the wedges home into the tenon of the blind and pre-loaded mortise and tenon joint of an embodiment of the present invention;

FIG. 8 is a diagrammatic front view taken generally in the direction of ARROW 8 in FIG. 7 illustrating the positions of the wedges in hidden lines;

FIGS. 8A-8B are a flow chart of the method of assembling the blind and pre-loaded mortise and tenon joint of an embodiment of the present invention;

FIG. 9 is a diagrammatic front view similar to FIG. 8 of the initial step of milling out a pair of oval slots in line with the pair of wedges, respectively, in disassembling the blind and pre-loaded mortise and tenon joint of an embodiment of the present invention;

FIG. 10 is a diagrammatic cross sectional view taken along LINE 10-10 in FIG. 9;

FIG. 11 is a diagrammatic cross sectional view of a next step of threading a threaded rod into the threaded blind bore of the base of the wedge of an embodiment of the present invention;

FIG. 12 is a diagrammatic cross sectional view of a next step of inserting a washer onto and threading a nut onto the threaded rod of an embodiment of the present invention;

FIG. 13 is a diagrammatic cross sectional view of a next step of tightening the nut on the threaded rod so as to begin to withdraw the at least one wedge from the at least one blind slot of tenon of first joint part;

FIG. 14 is a diagrammatic cross sectional view of a final step of withdrawing the at least one wedge from the at least one blind slot of tenon of first joint part to thereby be able to withdraw the tenon of the first part from the mortise of the second part; and

FIGS. 14A-14B are a flow chart of the method of disassembling the blind and pre-loaded mortise and tenon joint of an embodiment of the present invention.

### 4. LIST OF REFERENCE NUMERALS UTILIZED IN THE DRAWINGS

### A. General

20 blind and pre-loaded mortise and tenon joint of embodiment of present invention

### B. Overall Configuration of Blind and Pre-Loaded Mortise and Tenon Joint 10

22 first joint part
24 second joint part
26 at least one wedge
28 tenon of first joint part 22
30 mortise of second joint part 24

### C. Specific Configuration of Tenon 28 of First Joint Part 22 and Mortise 30 of Second Joint Part 24

32 at least one blind slot of tenon 28 of first joint part 22
34 pair of opposing and rearwardly diverging surfaces of mortise 30 of second joint part 24

### D. Specific Configuration of Wedge 26

36 base of wedge 26
38 pair of triangular side faces of wedge 26
40 pair of principal side faces of wedge 26
42 peak of wedge 26
44 threaded blind bore of base 36 of wedge 26

### E. Method of Disassembling Blind and Pre-Loaded Mortise and Tenon Joint 10

46 at least one oval slot of second joint part 24
48 threaded rod
50 washer
52 nut

### 5. DETAILED DESCRIPTION OF THE PREFERRED EMBODIMENTS

### A. General

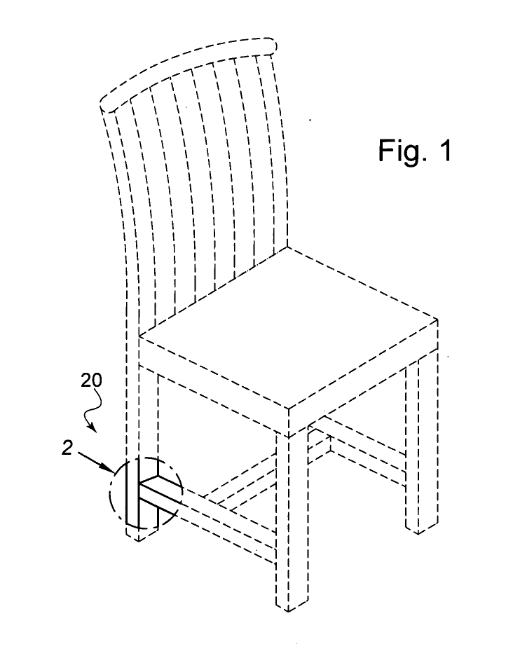

Referring now to the figures, in which like numerals indicate like parts, and particularly to FIG. 1, which is a diagrammatic perspective view of a chair utilizing the blind and pre-loaded mortise and tenon joint of an embodiment of the present invention, the blind and pre-loaded mortise and tenon joint of an embodiment of the present invention is shown generally at 20.

### B. Overall Configuration of the Blind and Pre-Loaded Mortise and Tenon Joint 10

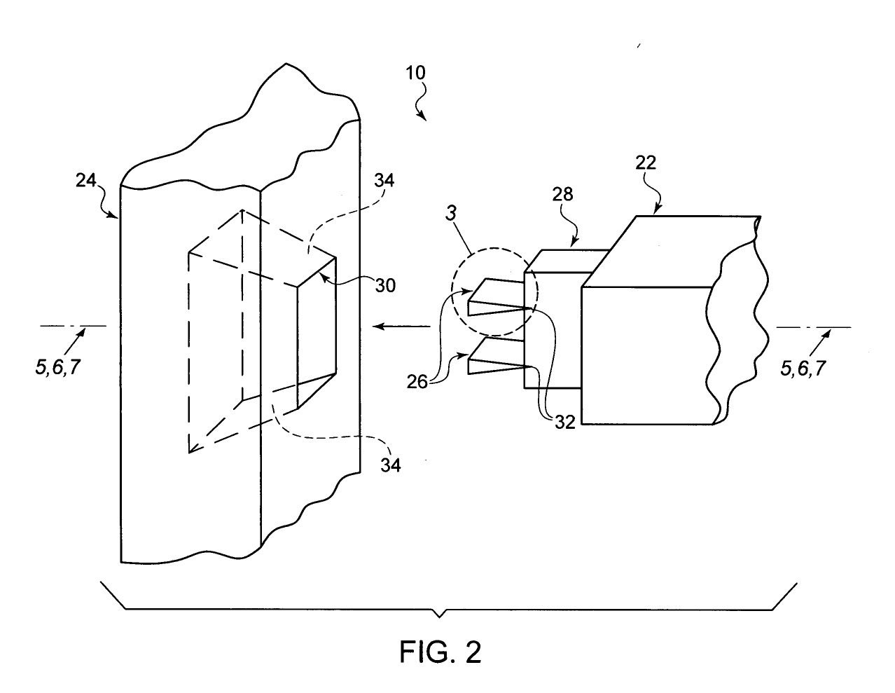

The overall configuration of the blind and pre-loaded mortise and tenon joint 10 can best be seen in FIG. 2, which is an enlarged and exploded diagrammatic perspective view of the area generally enclosed in the dotted curve identified by ARROW 2 in FIG. 1 of the blind and pre-loaded mortise and tenon joint of an embodiment of the present invention, and as such, will be discussed with reference thereto.

The blind and pre-loaded mortise and tenon joint 10 comprises a first joint part 22, a second joint part 24, and at least one wedge 26. The first joint part 22 has a tenon 28 extending outwardly therefrom. The second joint part 24 has a mortise 30 extending therein. The at least one wedge 26 is pre-loaded into the tenon 28 of the first joint part 22 before the tenon 28 of the first joint part 22 is inserted into the mortise 30 of the second joint part 24 so as to allow the tenon 28 of the first joint part 22 to expand against the mortise 30 of the second joint part 24 as the at least one wedge 26 drives further into the tenon 28 of the first joint part 22 by engaging the mortise 30 of the second joint part 24 until the tenon 28 of the first joint part 22 bottoms out in the mortise 30 of the second joint part 24 at which time the tenon 28 of the first joint part 22 is blindly captured in the mortise 30 of the second joint part 24.

### C. Specific Configuration of the Tenon 28 of the First Joint Part 22 and the Mortise 30 of the Second Joint Part 24

The tenon 28 of the first joint part 22 is normally rectangularly shaped, and has at least one blind slot 32 therein. The mortise 30 of the second joint part 24 is trapezoidal shaped, and is defined by a pair of opposing and rearwardly diverging surfaces 34.

The at least one wedge 26 is pre-loaded into the at least one blind slot 32 of the tenon 28 of the first joint part 22, respectively, before the tenon 28 of the first joint part 22 is inserted into the mortise 30 of the second joint part 24 so as to allow the tenon 28 of the first joint part 22 to expand against the pair of opposing and rearwardly diverging surfaces 34 of the mortise 30 of the second joint part 24 once the at least one wedge 26 has bottomed out in the mortise 30 of the second joint part 24 and thereby have the tenon 28 of the first joint part 22 blindly captured in the mortise 30 of the second joint part 24.

### D. Specific Configuration of the Wedge 26

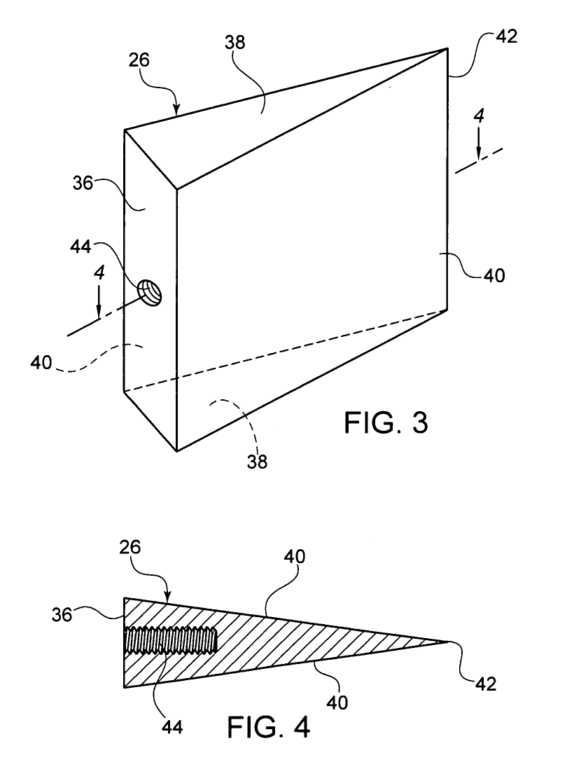

The specific configuration of the wedge 26 can best be seen in FIGS. 3 and 4, which are, respectively, an enlarged diagrammatic perspective view of the area generally enclosed by the dotted curve identified by ARROW 3 in FIG. 2 of the wedge of the blind and pre-loaded mortise and tenon joint of an embodiment of the present invention, and a diagrammatic cross sectional view taken along LINE 4-4 in FIG. 3, and as such, will be discussed with reference thereto.

The wedge 26 has a base 36, a pair of triangular side faces 38, and a pair of principal side faces 40. The pair of principal side faces 40 of the wedge 26 meet at a peak 42.

The base 36 of the wedge 26 has a threaded blind bore 44 that extends centrally and axially therein.

The peak 42 of the at least one wedge 26 is pre-loaded into the at least one blind slot 32 of the tenon 28 of the first joint part 22, respectively, before the tenon 28 of the first joint part 22 is inserted into the mortise 30 of the second joint part 24 so as to allow the tenon 28 of the first joint part 22 to expand against the pair of opposing and rearwardly diverging surfaces 34 of the mortise 30 of the second joint part 24 as the at least one wedge 26 drives further into the tenon 28 of the first joint part 22 until the tenon 28 of the first joint part 22 bottoms out in the mortise 30 of the second joint part 24 at which time the tenon 28 of the first joint part 22 is blindly captured in the mortise 30 of the second joint part 24.

### E. Method of Assembling the Blind and Pre-Loaded Mortise and Tenon Joint 10

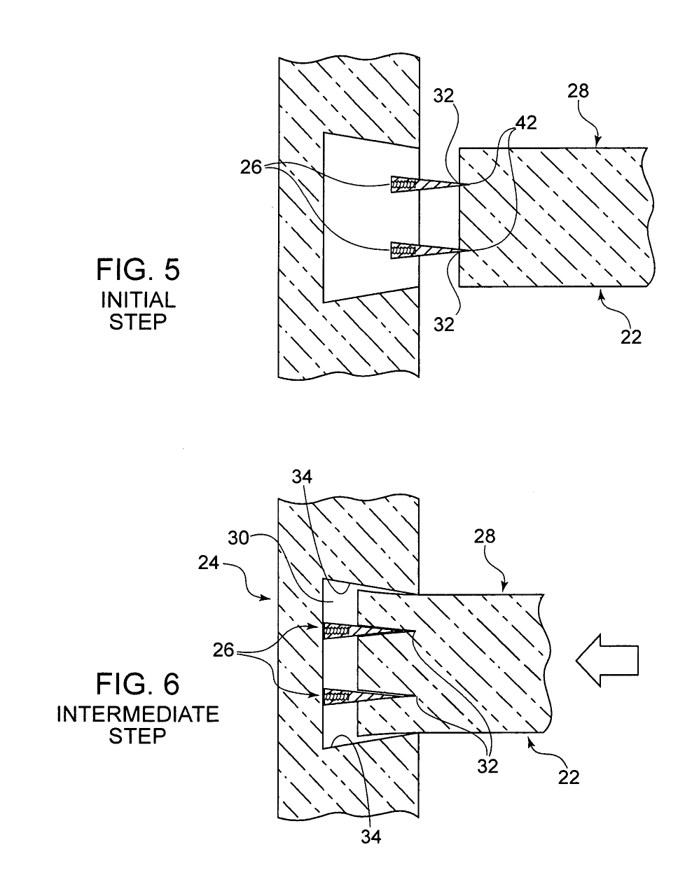

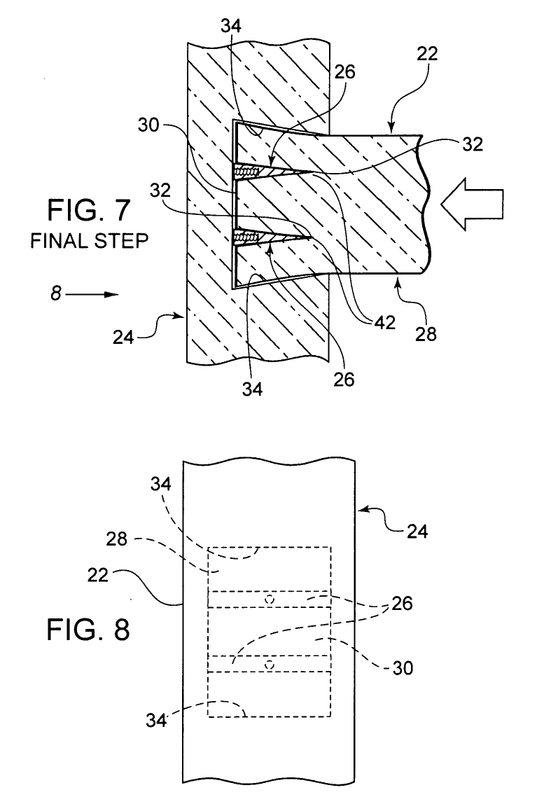

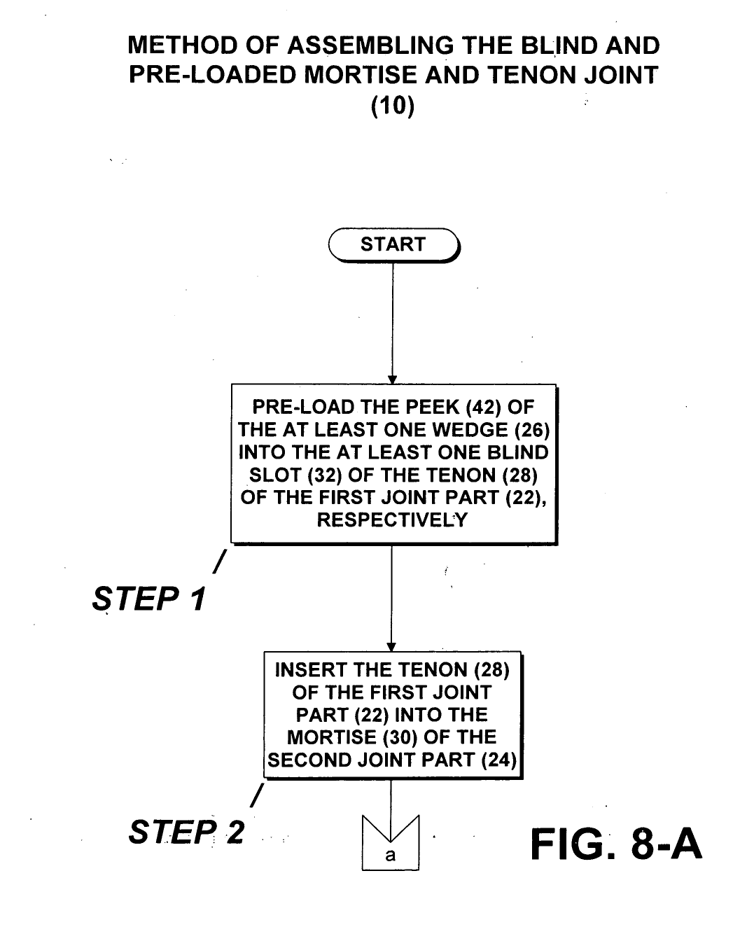

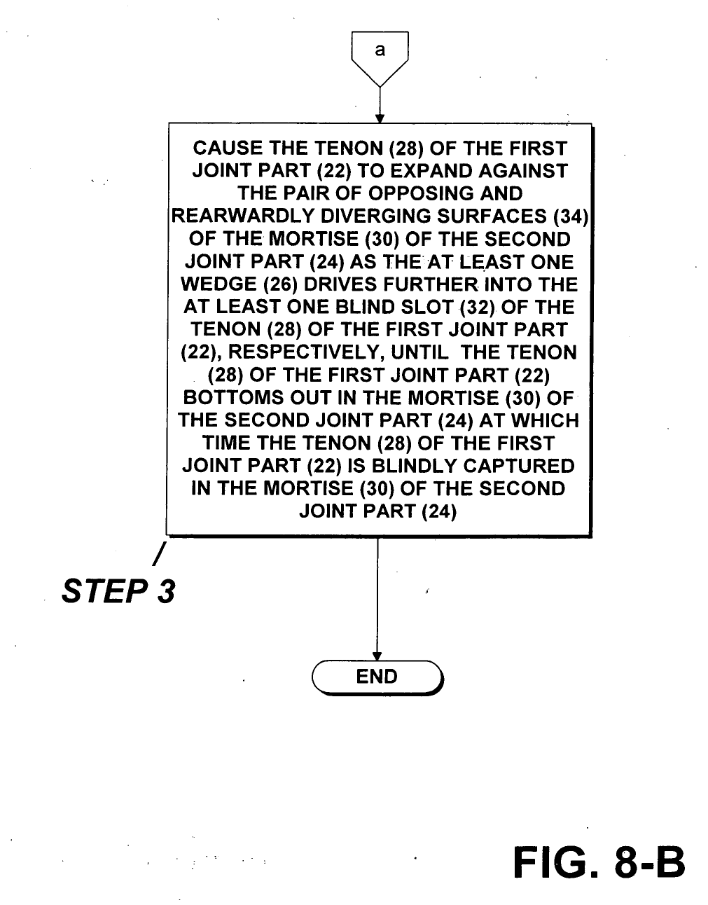

The method of assembling the blind and pre-loaded mortise and tenon joint 10 can best be seen in FIGS. 5-7, 8, 8A, and 8B which are, respectively, an enlarged diagrammatic cross sectional view taken along LINE 5-5 in FIG. 2 of the initial step of inserting the wedges into the tenon of the blind and pre-loaded mortise and tenon joint of an embodiment of the present invention, an enlarged diagrammatic cross sectional view taken along LINE 6-6 in FIG. 2 of the intermediate step of bottoming out the wedges in the mortise of the blind and pre-loaded mortise and tenon joint of an embodiment of the present invention, an enlarged diagrammatic cross sectional view taken along LINE 7-7 in FIG. 2 of the final step of driving the wedges home into the tenon of the blind and pre-loaded mortise and tenon joint of an embodiment of the present invention, a diagrammatic front view taken generally in the direction of ARROW 8 in FIG. 7 illustrating the positions of the wedges in hidden lines, and a flow chart of the method of assembling the blind and pre-loaded mortise and tenon joint of an embodiment of the present invention, and as such, will be discussed with reference thereto.
STEP 1: As shown in FIGS. 5 and 8A, pre-load the peak 42 of the at least one wedge 26 into the at least one blind slot 32 of the tenon 28 of the first joint part 22, respectively;
STEP 2: As shown in FIGS. 6 and 8A, insert the tenon 28 of the first joint part 22 into the mortise 30 of the second joint part 24; and
STEP 3: As shown in FIGS. 6 and 8B, cause the tenon 28 of the first joint part 22 to expand against the pair of opposing and rearwardly diverging surfaces 34 of the mortise 30 of the second joint part 24 as the at least one wedge 26 drives further into the at least one blind slot 32 of the tenon 28 of the first joint part 22, respectively, until, as shown in FIGS. 7, 8, and 8B, the tenon 28 of the first joint part 22 bottoms out in the mortise 30 of the second joint part 24 at which time the tenon 28 of the first joint part 22 is blindly captured in the mortise 30 of the second joint part 24.

### F. Method of Disassembling the Blind and Pre-Loaded Mortise and Tenon Joint 10

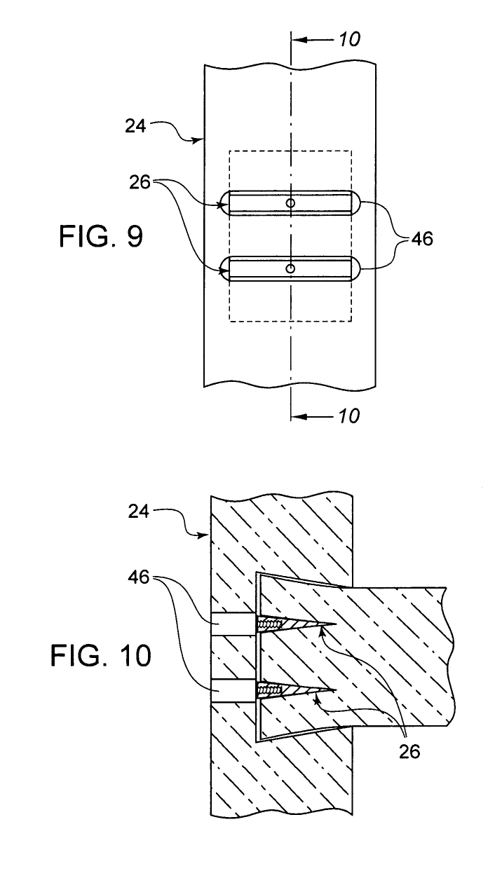

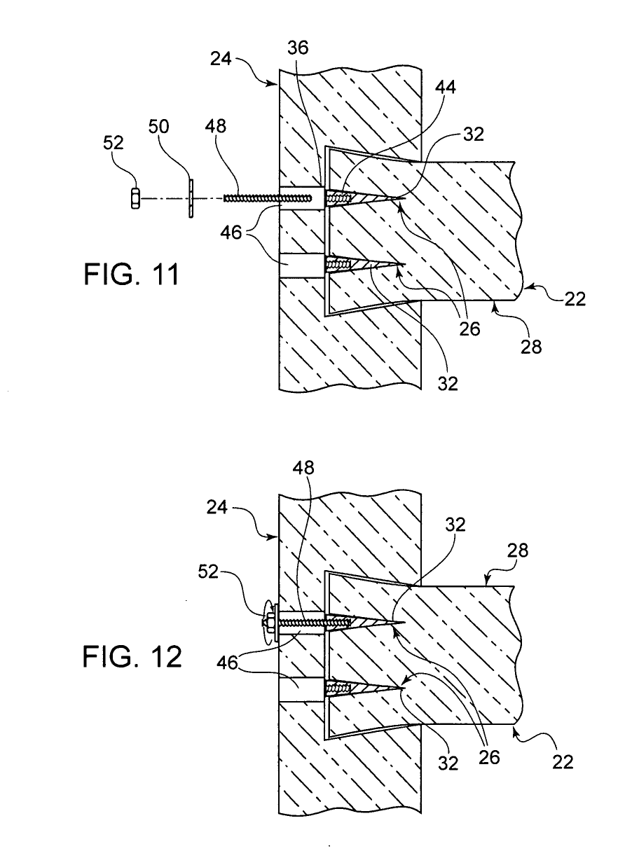

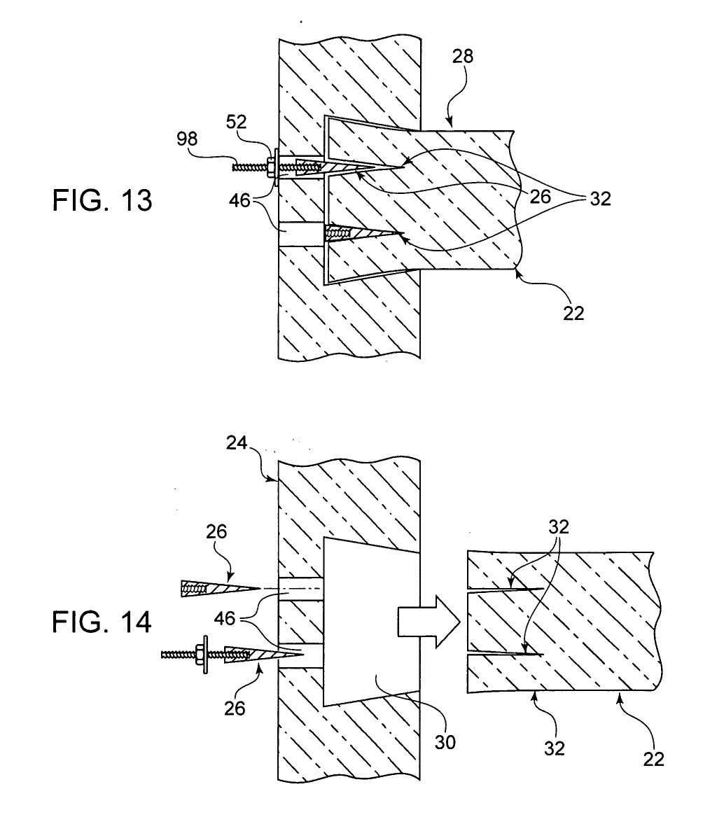

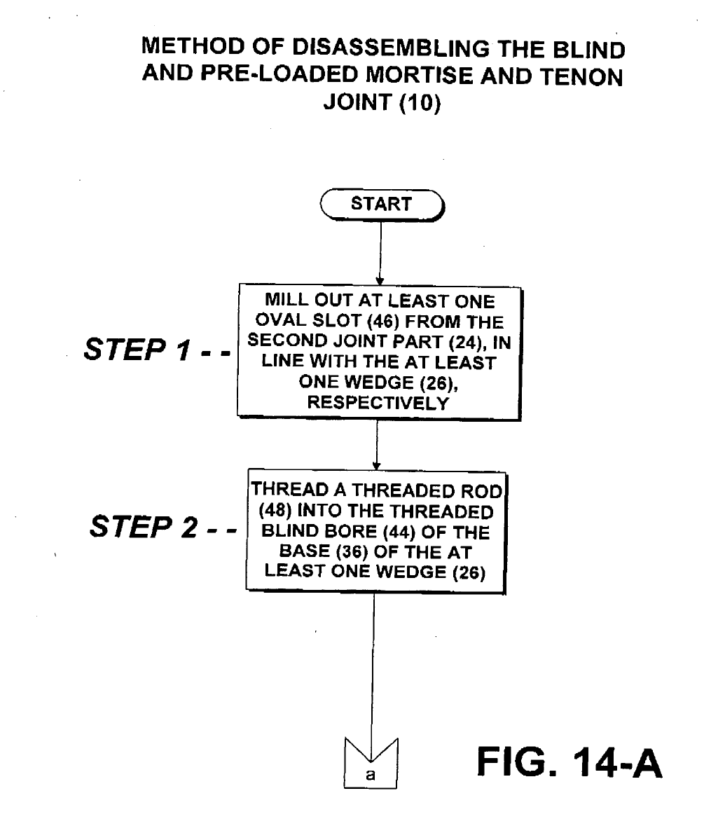

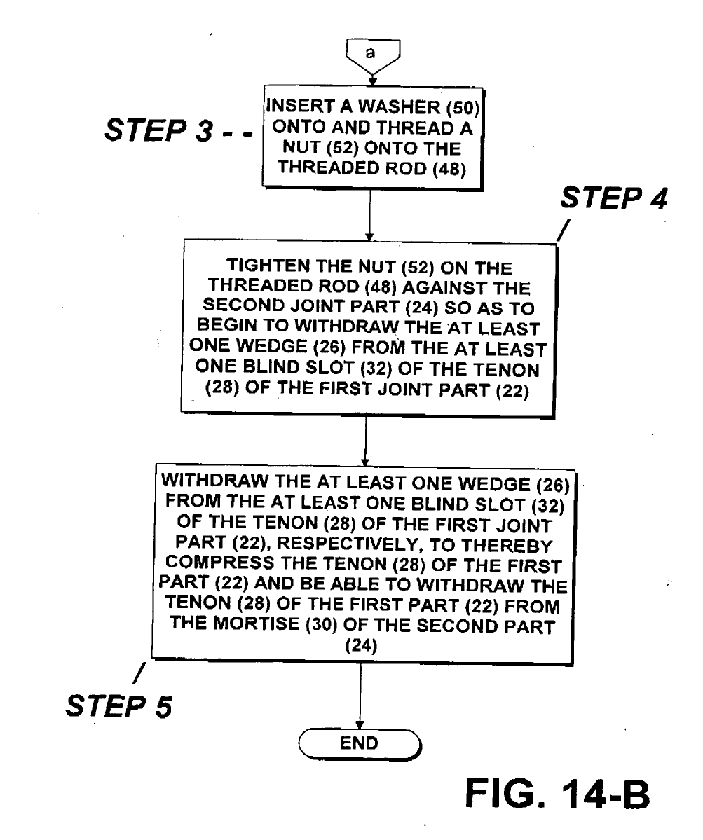

The method of disassembling the blind and pre-loaded mortise and tenon joint 10 can best be seen in FIGS. 9-14, 14A, and 14B, which are, respectively, a diagrammatic front view similar to FIG. 8 of the initial step of milling out a pair of oval slots in line with the pair of wedges, respectively, in disassembling the blind and pre-loaded mortise and tenon joint of an embodiment of the present invention, a diagrammatic cross sectional view taken along LINE 10-10 in FIG. 9, a diagrammatic cross sectional view of a next step of threading a threaded rod into the threaded blind bore of the base of the wedge of an embodiment of the present invention, a diagrammatic cross sectional view of a next step of inserting a washer onto and threading a nut onto the threaded rod of an embodiment of the present invention, a diagrammatic cross sectional view of a next step of tightening the nut on the threaded rod so as to begin to withdraw the at least one wedge from the at least one blind slot of tenon of first joint part, a diagrammatic cross sectional view of a final step of withdrawing the at least one wedge from the at least one blind slot of tenon of first joint part to thereby be able to withdraw the tenon of the first part from the mortise of the second part, and a flow chart of the method of disassembling the blind and pre-loaded mortise and tenon joint of an embodiment of the present invention, and as such, will be discussed with reference thereto, and a flow chart of the method of disassembling the blind and pre-loaded mortise and tenon joint of an embodiment of the present invention, and as such, will be discussed with reference thereto.
STEP 1: As shown in FIGS. 9, 10, and 14A, mill out at least one oval slot 46 from the second joint part 24, in line with the at least one wedge 26, respectively;
STEP 2: As shown in FIGS. 11 and 14A, thread a threaded rod 48 into the threaded blind bore 44 of the base 36 of the at least one wedge 26;
STEP 3: As shown in FIGS. 11 and 14B, insert a washer 50 onto and thread a nut 52 onto the threaded rod 48;
STEP 4: As shown in FIGS. 12, 13, and 14B, tighten the nut 52 on the threaded rod 48 against the second joint part 24 so as to begin to withdraw the at least one wedge 26 from the at least one blind slot 32 of the tenon 28 of first joint part 22; and
STEP 5: As shown in FIGS. 14 and 14B, withdraw the at least one wedge 26 from the at least one blind slot 32 of the tenon 28 of the first joint part 22, respectively, to thereby compress the tenon 28 of the first part 22 and be able to withdraw the tenon 28 of the first part 22 from the mortise 30 of the second part 24.

### G. Impression

It will be understood that each of the elements described above or two or more together may also find a useful application in other types of constructions differing from the types described above.

While the embodiments of the present invention have been illustrated and described as embodied in a blind and pre-loaded mortise and tenon joint, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A blind and pre-loaded mortise and tenon joint, comprising:
a) a first joint part;
b) a second joint part; and
c) at least one wedge;
wherein said first joint part has a tenon extending outwardly therefrom;
wherein said second joint part has a mortise extending therein; and
wherein said at least one wedge is pre-loaded into said tenon of said first joint part before said tenon of said first joint part is inserted into said mortise of said second joint part so as to allow said tenon of said first joint part to expand against said mortise of said second joint part as said at least one wedge drives further into said tenon of said first joint part by engaging the mortise of the second joint part until the tenon of the first joint part bottoms out in the mortise of the second joint part at which time the tenon of the first joint part is blindly captured in the mortise of the second joint part.

2. The joint of claim 1, wherein said tenon of said first joint part is normally rectangularly shaped.

3. The joint of claim 1, wherein said tenon of said first joint part has at least one blind slot therein.

4. The joint of claim 1, wherein said mortise of said second joint part is trapezoidal shaped.

5. The joint of claim 3, wherein said mortise of said second joint part is defined by a pair of opposing and rearwardly diverging surfaces.

6. The joint of claim 5, wherein said at least one wedge is pre-loaded into said at least one blind slot of said tenon of said first joint part, respectively, before said tenon of said first joint part is inserted into said mortise of said second joint part so as to allow said tenon of said first joint part to expand against said pair of opposing and rearwardly diverging surfaces of said mortise of said second joint part as said at least one wedge drives further into said tenon of said first joint part by engaging said mortise of said second joint part until said tenon of said first joint part bottoms out in said mortise of said second joint part at which time said tenon of said first joint part is blindly captured in said mortise of said second joint part.

7. The joint of claim 5, wherein said wedge has a base;
wherein said wedge has a pair of triangular side faces;
wherein said wedge has a pair of principal side faces; and
wherein said pair of principal side faces of said wedge meet at a peak.

8. The joint of claim 7, wherein said base of said wedge has a threaded blind bore that extends centrally and axially therein.

9. The joint of claim 7, wherein said peak of said at least one wedge is pre-loaded into said at least one blind slot of said tenon of said first joint part, respectively, before said tenon of said first joint part is inserted into said mortise of said second joint part so as to allow said tenon of said first joint part to expand against said pair of opposing and rearwardly diverging surfaces of said mortise of said second joint part as said at least one wedge drives further into said at least one blind slot of said tenon of said first joint part by engaging the mortise of the second joint part until said tenon of said first joint part bottoms out in said mortise of said second joint part at which time said tenon of said first joint part is blindly captured in said mortise of said second joint part.

10. The joint of claim 8, further comprising said second part having at least one slot;
wherein said at least one slot of said second joint part communicates with said mortise in said second joint apart; and
wherein said at least one slot of said second joint part is so shaped so as to allow said at least one wedge to pass therethrough.

11. The joint of claim 10, further comprising at threaded rod; and
wherein said threaded rod extends through said at least one slot of said second joint part and replaceably threads into said threaded blind bore of said base of said at least one wedge.

12. The joint of claim 11, further comprising:
a) a washer; and
b) a nut;
wherein said washer freely receives said threaded rod; and
wherein said nut threadably engages onto said threaded rod after said washer freely receives said threaded rod so by tightening said nut on said threaded rod against said second joint part, said at least one wedge is withdrawn from said at least one blind slot of said tenon of said first joint part.

13. A kit for assembling and disassembling a mortis and tenon joint component comprising a set of at least one of the following set of components:
a) a wedge having a threaded blind bore in a base;
b) a threaded rod that matches said threaded blind bore in said base of said wedge;
c) a washer which loosely fits around said threaded rod; and
d) a nut having a thread which matches said thread rod.

14. A method of assembling a blind and pre-loaded mortise and tenon joint, wherein the joint includes a first joint part having a tenon with at least one blind slot, a second joint part having a mortise with a pair of opposing and rearwardly diverging surfaces, and at least one wedge having a peak, said method comprising the steps of:
a) pre-loading the peak of the at least one wedge into the at least one blind slot of the tenon of the first joint part, respectively;
b) inserting the tenon of the first joint part into the mortise of the second joint part; and
c) causing the tenon of the first joint part to expand against the pair of opposing and rearwardly diverging surfaces of the mortise of the second joint part as the at least one wedge drives further into the at least one blind slot of the tenon of the first joint part, respectively, until the tenon of the first joint part bottoms out in the mortise of the second joint part at which time the tenon of the first joint part is blindly captured in the mortise of the second joint part.

15. A method of disassembling a blind and pre-loaded mortise and tenon joint, wherein the joint includes a first joint part having a tenon with at least one blind slot, a second joint part having a mortise, at least one wedge having a base with a threaded blind bore, and a threaded rod, said method comprising the steps of:
a) milling out at least one oval slot from the second joint part, in line with the at least one wedge, respectively;
b) threading the threaded rod into the threaded blind bore of the base of the at least one wedge;
c) inserting a washer onto, and threading a nut onto, the threaded rod;
d) tightening the nut on the threaded rod so as to begin to withdraw the at least one wedge from the at least one blind slot of the tenon of the first joint part; and
e) withdrawing the at least one wedge from the at least one blind slot of the tenon of the first joint part, respectively, to thereby compress the tenon of the first part and be able to withdraw the tenon of the first part from the mortise of the second part.
